(19) United States
(12) Patent Application Publication
(10) Pub. No.: US 2015/0081450 A1
(43) Pub. Date: Mar. 19, 2015

(54) SYSTEM AND METHOD FOR SOCIAL NETWORK AND E-COMMERCE SUPPORTING USER GOALS

(71) Applicant: Alyssa Noel Bean, Middleton, MA (US)

(72) Inventor: Alyssa Noel Bean, Middleton, MA (US)

(21) Appl. No.: 14/458,409

(22) Filed: Aug. 13, 2014

Related U.S. Application Data
(60) Provisional application No. 61/960,256, filed on Sep. 14, 2013.

(51) Int. Cl. G06Q 30/02; G06Q 50/00

(52) U.S. Cl. CPC G06Q 30/0269; G06Q 50/01
USPC 705/14.66

(57) ABSTRACT

A system and method that creates a list of life goals for each individual user based on user-specific inputs including desires, geography, demographics, interests, community, relationships, lifestyle, and personal background, and matches the user to pertinent information including friends, other users, and merchants that have similar interests, experiences, or services to facilitate the desired accomplishment of user fulfilling their life goals. System and method provides merchant opportunities for user to act on, purchase, sign up for or participate in activities and products related to the user's life goals. System and method enables users to share their experiences, recommendations, opinions, photographs, and videos of the life goals they have achieved or are working to achieve in a social network environment where other users benefit from each other's experience and may support each other in the fulfillment of life goals.

### BACKGROUND

There are known social networking systems and methods such as demonstrated in Facebook, Myspace, and Google+, that allow users to connect with other users as friends, and share photos, videos, comments, likes and dislikes, opinions and experiences. There are sites such as Twitter Facebook, and Instagram that allow a user to post their current status of what they are doing, liking, and observing in life currently or previously. There are also merchant and distributor sites that allow users to purchase discounted products and travel services such as Travelocity, Expedia and Groupon. None of these systems and methods however, offer a dynamic view of users future goals and aspirations with ties to friends and merchants that can efficiently assist the user in the fulfillment of these aspirations and life goals.

The present invention involves creating a social network around the future goals and aspirations of individual users and efficiently supports the user in the fulfillment of their goals through efficient social networking support of their friends, family, associates and merchants that are interested and relevant in helping user fulfill their goals.

### BRIEF DESCRIPTION OF DRAWINGS

The foregoing and other advantages and features of the invention will become more apparent from the detailed description of the preferred embodiments of the invention given below with reference to the accompanying drawings in which:

FIG. 1 is a schematic block diagram of the system in accordance with an embodiment of the invention; and

FIG. 2 is an illustration of an example of an input screen describing a user's goal as it is entered into the system;

FIG. 3 is an exemplary block diagram illustrating 3 the system search capability which may be present anywhere within the user portal experience;

FIG. 4 is an exemplary block diagram illustrating the interaction of users and vendors within the system associated with processing a transaction

### DETAILED DESCRIPTION OF THE PRESENT INVENTION

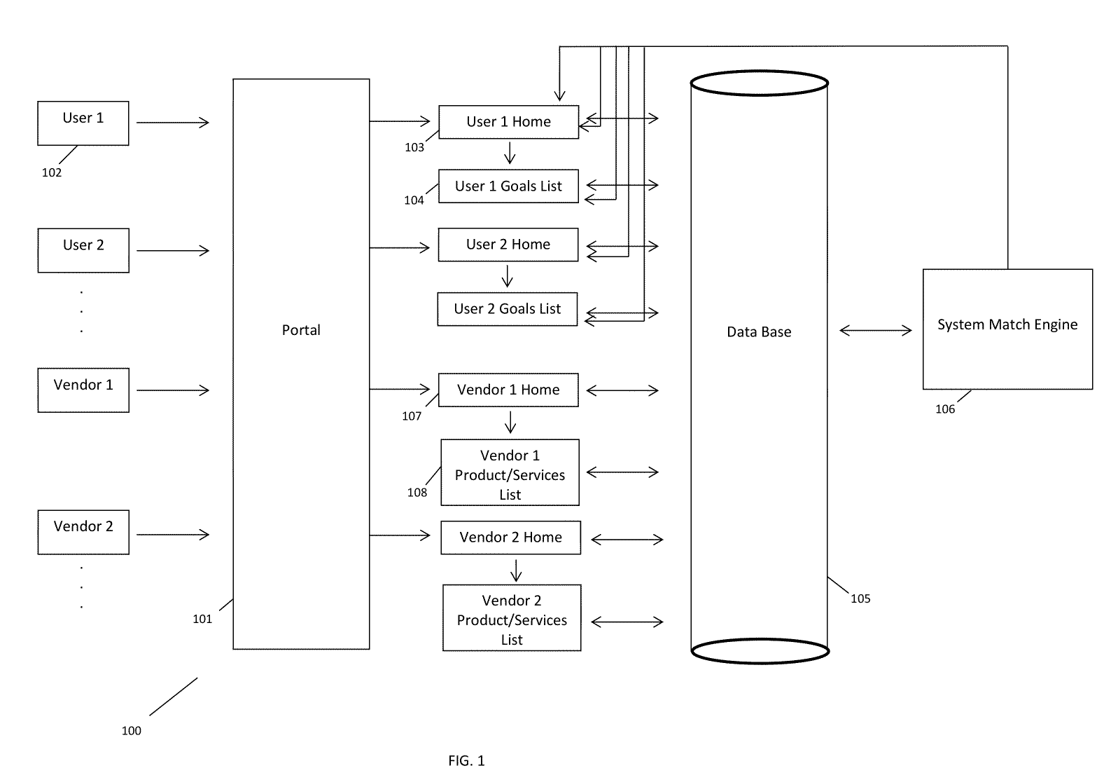

FIG. 1 is a schematic block diagram of an exemplary environment for generating a system 100 for users to list and fulfill their goals and for vendors (or merchants) to advertise and sell products and services in support of fulfilling users goals. System 100 comprises a portal 101 that is accessed via the web or Internet (not shown). A portal or gateway for the World Wide Web site is a starting site for users when they get connected to the web. Users may access the portal from any number of devices that are internet connected such as personal computers, cell phones, and tablets. The system provides a method of registering users to the web site through the portal 101 to connect user 102 to home page 103. The registration process requires the user to set up a login account and password and provide relevant personal information such as name, email, age or birthday, and current address. Numerous specific users connect to the site and their user home page 103. From the home page 103, users can navigate to their Goal List 104. Users may manually search for friends within the system and request through the system to be friends. Once friend request is accepted the system allows user and friend to see detailed information about each other as users may specify in their profile setup such as under privacy settings. Users may import an email list from other programs such as email programs or other social networking websites and request for system to use these emails to automatically send a friend request to any system users that match and email address in the email list. The system would then automatically make all matching friend requests for the user. All of the information from system 100 is stored in database 105 which interacts directly with web pages within the site including 103 and 104. Users also have the option to Follow a user, rather than send a Friend Request. This can be done by the user clicking on a follow link or button so the System knows that User requests information updates from this area. If a user follows another user or vendor, all public content that the followed user posts will be directed to the following user's news feed.

Users may add goals to their account as they wish by specifying the goal attributes including goal description, category, location, target completion date, friends they desire to be including in the goal, and vendors or merchants and their respective products that user is considering to help fulfill the goal.

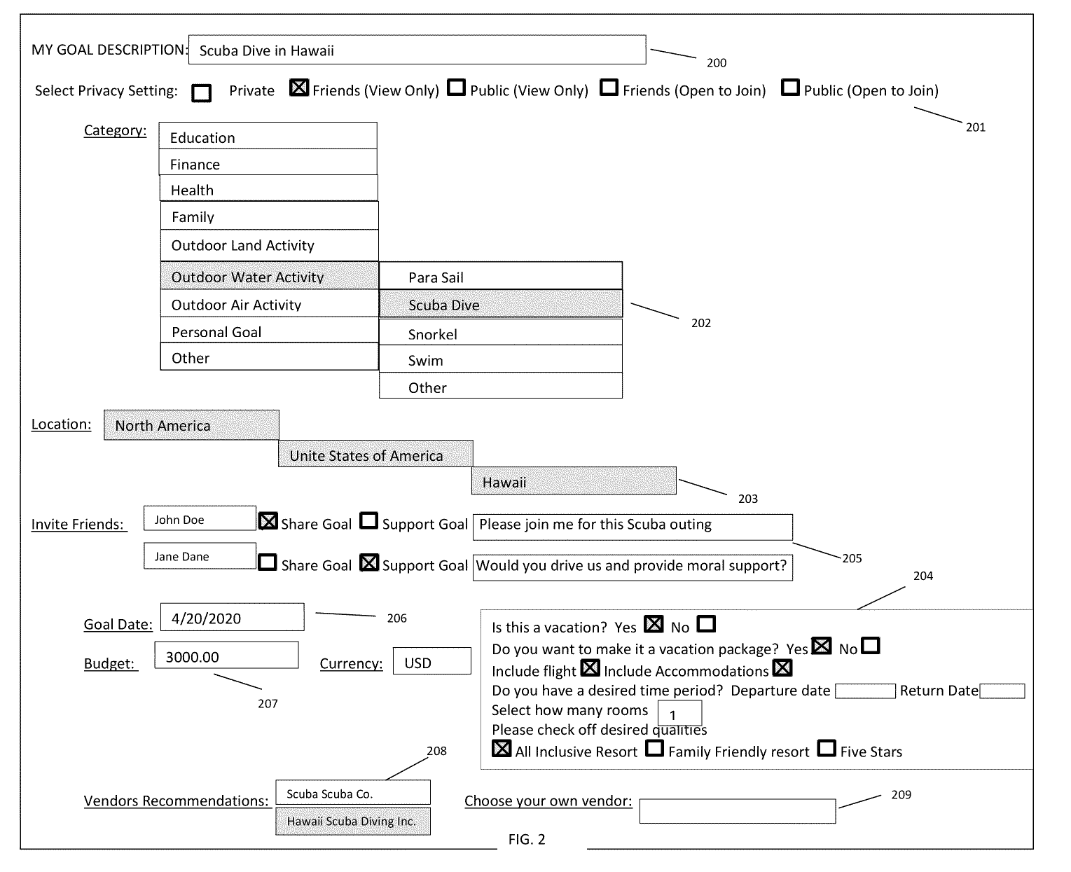

FIG. 2 illustrates one possible embodiment of a method for users to add a goal to their profile or account. 201 illustrates how the user can set the privacy of their goal in categories such as Private, Friends (View Only), Public (View Only), Friends (Open to Join) or Public (Open to Join). If a user selects Private, only the user themselves can view that specific item on their goals list. If a user selects Friends (View Only) that item on their list is able to be seen by the other users in their friends list, versus if they choose Friends (Open to Join) where their friends can both see the item, and also have the opportunity to elect to join this item/goal in which case this item would show up on the friends' goals list who elected to join. If a user selects Public (View Only) all users who have accounts on this system are granted access to view this item. Public (Open to Join) allows all users on this system to elect to participate in this item/goal in which case this item would show up on these users' goals list who elected to join. 202 illustrates a multi-stage pull down method for user to identify the category for their specific user goal. For example, FIG. 2 shows the user chosing Outdoor Water Activity/Scuba Dive as the category for their goal. 203 illustrates how a user can specify the location of the goal. This example shows user choice of North America/United States of America/Hawaii. Menus 202 and 203 may be a single level, two level or three or more levels. 204 illustrates the users ability to specify the gfoal as a vacation package, and if so, specify details such as including flights, accommodations, number of rooms, hotel amenities, and desired vacation time. 204 provides information to the that enables the System Match Engine 106 to match user's goal interests with the appropriate merchant(s) or vendor(s) product or service offerings. 205 Illustrates the users option to include specific friends in the goal. In this example, the user has chosen to invite their friends John Doe and Jane Dane to either Share or Support this goal. If a user is requesting a friend to Share the goal, it is asking the friend to participate and complete this goal with the user that has sent the request. If a user requests a friend to Support the goal, the user is requesting that this friend be involved in some way, but not expecting them to participate in the goal. The user creating this goal has the option to add a description to these requests. In this example, the user is requesting Jane Dane to Support them by driving them to the location of the Scuba Diving event, and to come for moral support. The invited friends have the option to accept or decline the invitations they receive through the system. 206 illustrates the option the user has to create a deadline for the specific goal. If a Goal Date is set, the system will notify the user of any approaching deadlines from their goals list. 207 illustrates the option of setting a desired budget for the goal. 208 illustrates a list of recommended vendors or merchants that would best suit the user's desired requirements based on the information the user input such as in 202, 203, 204, 206 and 207. The user has the option to choose from this list but it is not required. 209 illustrates the users option to select a vendor on their own. When the user completes the initial input of the goal as illustrate in FIG. 2 or updates an existing goal, they complete the process by pressing a button of command key such as submit or update button after which the goal is updated in database 105 and recorded to users goal list and system automatically presents invitations and publishes goal information throughout system according to the user's information designated for the goal.

Referring back to FIG. 1, vendors may enter the system similar to users via portal 101 to their vendor home page 107. Vendors may add all their demographic information and contact info such as location, company description and company website. Instead of adding goals as users do, vendors add products and/or services to their account and specify their products and services similar to goals as illustrated in FIG. 2 by including data such as category, location, dates offered, and pricing. A vendor also has the ability to create Special Offers that have a countdown, where users will have the ability to purchase an item/service for a discounted rate if purchased before the countdown for that item/service expires. Vendors have the ability to edit their profiles freely, except the review section of their Vendor page. The review section is the area of a vendor's profile where users have the ability to post comments and opinions based on their experiences with a particular vendor. Along with their comment, the user has the ability to rate the vendor on a scale of one to five stars if they so choose. This allows users to read unbiased reviews of vendors before making a purchase.

As illustrated in FIG. 1, information from home pages (103, 107), user goals (104), Product/Service List (108) and other pages the system may have that display or use vendor or user data are connected and stored in a database 105. A system match engine 106 is also connected to the database 105 and User home and user goals as in 103 and 104. The system match engine provides useful information to the user home pages (103, 107) and goal lists (104) for a given user such as other users with the similar goals, and vendor/merchant information, products, and services related to user's specific goals.

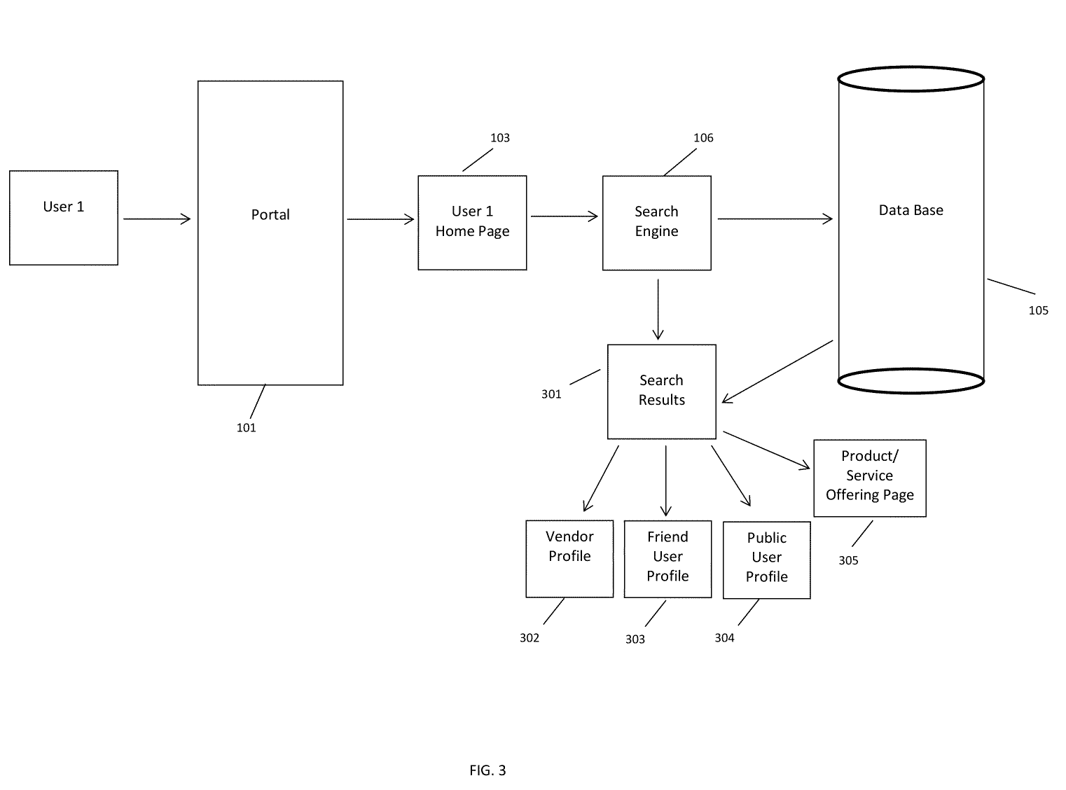

FIG. 3 illustrates the system search capability which may be present anywhere within the user portal experience and typically is a standard part of every page within the system such as in a search filed area at the top of every page (but may be placed at bottom or side or anywhere on page). For example, from the user home page 103, user may enter a search string regarding information about a subject, category, vendor, product, or person and the search engine 106 will access the system database 105 and return detailed search results information 301 that most closely matches the users search string. The search engine algorithm can provide more relevant results by matching up additional information in the users profile such as age, location, past goals, with the requested search information and results listing. This more efficient method provides user with more relevant information. From the search results, user can hyperlink directly to more detailed information from the results such as to vendor profiles 302, friend profiles 303, public profiles 304, and vendor product and/or service offerings 305. Within the friend profile, user may click view friends goals and add information such as a text posting, posting of support which may be noted as a “cheer”, or request to join a person's goal item or support a person's goal item.

As part of the System Match Engine, users may search for other users who share a specific goal. This allows users to put a friend request to such a user and collaborate on their common goals. This could allow users to join schedules and resources to attain their common goal.

Another aspect of the system is the ability for friends to send private messages to each other in real-time such that user may respond instantly. System may display which friends are currently logged in so user may know which friends are available to send real-time messages back and forth. Messages may be associated with or linked to a specific goal and the history of the messaging may be saved within the system for reference by the user at any time. This allows users to keep separate message histories organized by goal for efficient reference and planning purposes in support of achieving their goal.

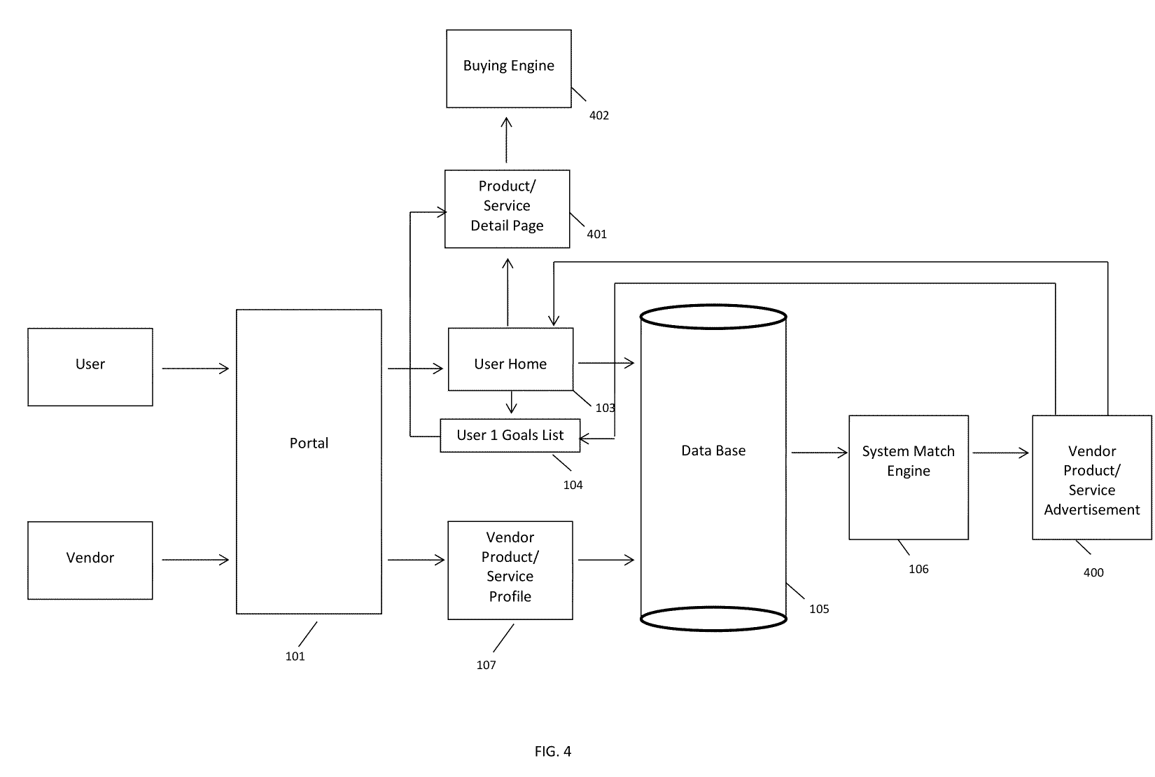

FIG. 4 illustrates how the user is connected with vendor products and/or services via the system and how the connections may generate e-commerce between users and vendors. One embodiment of this connection method is shown in FIG. 4 whereby the user's home 103 is automatically populated with advertisements and/or information related to vendor products and/or services that are matched to user as determined by the System Match Engine 106, and such related vendor information hyperlinks to Product/Services Detail Page 401. The System Match Engine 106 matches user profile information such as location, age, gender, user's prior search history (within and outside of the system) and other demographic information and information from user goals such as is illustrated in FIG. 2 (and described previously) and system information tied to goals such as friend recommendations, other user recommendations, “cheers” or Star Ratings to vendor products and/or services information including all the attributes associated with products and/or services such as category, location, pricing, dates available and recommendations. The System Match Engine 106 may also adjust the ranking order of these matches by taking into account vendor advertisement payments from vendors/service providers such that the match algorithm increases the ranking of products/services information based on the advertising payment. In such case, a vendor pays the system provider a fee to improve their ranking and likelihood that their product and/or service information will be displayed to user for user's consideration. The vendor advertising payment may be calculated using various business models including payment on a per-click basis (payment assessed only after user clicks on the vendor information related to the paid advertisement) or payment may be assessed a per-displayed basis to user or payment may be assessed as a flat-fee basis or as a percentage of the price of the vendor product and/or service upon user purchasing or signing up for vendor's product or service. Once the system match engine 106 completes the rank-ordered matching according to the above description, the top items are displayed for consideration by user. Since the vendor products and/or services are closely matched to the user's background and goals, this method provides a useful and efficient way for user to consider products and/or services to fulfill his/her goals. In a similar fashion, these top-matched vendor products and/or services 400 may be displayed on user's goals page 104 preferably alongside related user information. Matched product and/or service information 400 may be displayed anywhere throughout the system and is preferentially displayed alongside of related or matched user information. The system may display links that provide this match information in more detail; for example a goal listing may have a link that is labeled “Products/Services Matched to This Goal”, and when selected, system will display a detailed list of the results from System Match Engine 106 related to this specific area or goal.

An alternate embodiment of the above would not include vendor advertising payments into the System Engine Search 106 for displaying search results, but instead simply provide a separate advertisement display on any or all pages throughout the system including search pages. Such advertisements may still be matches to the content of the page on which it is displayed as outlined above, but simply displayed separately and not embedded in the user's search results.

Matched listing from the system match engine 106 may also be ranked or categorized such as putting a measuring attribute to indicate how well listing is matched to user's search or related information on the page such as a goal. For example a product may be displayed as a 96% matched to user goal #3. Another embodiment may show a measurement of match quality on a scale from 1 star to 5 star or similar ranking methods.

The system may further improve efficiency for users to find appropriate products/services to match their goals by allowing users to select customized searches for vendor products and/or services. System offers users the ability to search for matches by any criteria within their goals such as location, budget, category, date and star ratings. Another embodiment is that users may search based on recommendations of friends or users in general. The system may highlight goals of other users based on number of recommendation, number of “cheers”, number of page-views, or any other attribute that is tracked in the system.

Users may search for friends and read friends profiles and goals where they have security privates granted by their friends to view content. In viewing friends and/or other users goals, users may copy another person's goal to their listing by clicking a link such as “Add to My Goals”, whereby the system will automatically add a new goal for user and copy the relevant information to the new users goal and allow them to edit it further to customize it for themselves. Users may add a goal in a similar way by clicking the same type of link on a vendors' product/services page.

User may purchase/sign-up for/schedule a product/service from the Product/Service Detail Page 401 whereby they will be routed to a Buying Engine 402. The buying engine may be within the system and include a shopping cart, wanted items (or wish list), and a checkout function that allows users to finalize their purchase and pay for the item(s). Users may pay for items within Buying Engine 402 via any e-commerce method such as credit card, PayPal, or virtual money. As part of finalizing user's order, the system may allow for scheduling of the activity and provide guidance information of availability of product/services by all attributes such as date, location, dimensions, quantity and duration. The Buying Engine 402 may be integrated into vendor's website (outside of System 100) or user may simply be directed to pay vendor directly through the vendor's system, in which case, vendor may supply information back to System 100 so System 100 may make use for such information in updating the status of user information such as user's goals, schedules, and calendars.

Another key aspect of the system is its ability to organize date information contained in its database and provide detailed reports to users and vendors. User can click on My Calendar link to display user goal information formatted by date such as plotted on a calendar. This includes information on goal dates or deadlines, goal planning activities necessary to prepare for goals, user friends' birthdays, manual ad-in reminders written by user and vendor advertisements associated with specific user goals. All of this information is date-specific and organized in various formats including multi-year view, yearly view, monthly view, weekly view, daily view, and list view. Vendor advertisement information may be prioritized by System Match Engine which ranks and orders the information as described previously and illustrated in FIG. 4. Information may also be plotted on a geographic map to allow users to see their goals plotted by location and possible vendor/merchant products or services locations nearby.

Another key aspect of the system is its ability to provide useful and pertinent news feeds to a user. System will automatically provide one or more news feeds generated by the System Match Engine. One embodiment of the news feed will be Vendor Opportunities, where vendors are offering new, improved or timely products and/or services related to and matched well with one or more user goals. Another embodiment of the news feed is one that lists information posted by friends and followed users of a user which include status updates, photos, updated content, videos, etc. Another embodiment to this is a news feed of items which are only related to your goals.

Another key aspect of the system allows users to post the status of goals, pictures, videos, comments, and blogs about their general aspirations and/or specific goals. Status update may include setting such as thinking about, planned, started, and completed. This content may be tied specifically to a goal or posted generally within their account or home page. Users may comment on their own content and other user's content with the appropriate security approvals.

Another key aspect of the system allows users to create an Event and/or Fundraiser. If a user chooses to create an Event, user creates a page where they can store information for an upcoming event. Information can include description of the event, time, place, cost, etc. The user has the ability to send an invitation to specific friends through the system, or send an invitation to their entire friends list. They also have the option to choose their security settings for the group, Private, meaning only people invited can see this event through the system, Friends (View Only), which means only the user's friends can see the event through the portal but do not have the ability to attend unless invited, Friends (Open to Join), which means their entire friends list is allowed to view and attend the event, or Public, all users on the system have the ability to see and attend. After publishing the event page, an invitation notification will be sent to the user's friends who were invited and they have the option to RSVP in the form of going, not going, or maybe going. If a user creates a Fundraiser, they are creating a page to raise money for a cause/person/place/animal. The privacy settings and information for a Fundraiser page is the same as in the Event page. An event page however also connects to the Buying Engine 402 where users who were invited or have the ability to see the page have the ability to donate to this fundraiser via any e-commerce method such as credit card, PayPal, or virtual money.

1. A method of managing life goals in a social network environment, the method comprising:
storing a plurality of activities related to life goals for a plurality of users;
storing a plurality of vendor and merchant products and services that may be useful in supporting users fulfillment of life goals;
enabling users to access information regarding vendor or merchant products and services that are related to user's life goals.

2. The method of claim 1, wherein the majority of activities, when entered by user, are designated by date or time to be future activities.

3. The method of claim 1, wherein the plurality of activities is selected according to an affinity determined for the viewing user.

4. The method of claim 1, wherein at least one informational link comprises a dropdown menu.

5. The method of claim 1, further comprising attaching an active link associated with at least one of the plurality of activities, to at least one of the plurality of news items.

6. The method of claim 1, wherein the step of assigning an order comprises assigning the order according to a chronological order of occurrence of the news items.

7. The method of claim 1, further comprising displaying advertising with the plurality of news items.

8. The method of claim 1, further comprising searching the one or more news items for a predetermined character string.

9. The method of claim 1, further comprising applying a filter to the one or more news items to prevent news items regarding certain types of activities from being displayed.

10. The method of claim 1, further comprising dynamically limiting a number of the plurality of news items available for display.

11. The method of claim 1, wherein information related to vendor or merchant products or services permits user to purchase of one or more products or services.

12. The method of claim 1, wherein information related to vendor or merchant products or services permits user to schedule to purchase or use of one or more products or services.

13. The method of claim 1, wherein users add friends based on common life goals.

14. The method of claim 1, wherein users have the ability to encourage other users to complete life goals by pressing a button labeled “cheers.”

15. The method of claim 1, further comprising involvement of users in support of other users' life goals by indicating such support within the system and optionally investing time or resources in support of the goal.

16. The method of claim 1, further comprising involvement between users such that they share a life goal.

17. The method of claim 1, further comprising of a calendar customized to each user based on but not limited to life goals, goal deadlines, upcoming events, user friends' birthdays, manual ad-in reminders written by user and vendor advertisements associated with specific user goals.

18. The method of claim 1, further comprising of a world map that plots all events relating to friends' and public users' life goals and vendor products/services based on location.

19. The method of claim 1, further comprising of different degrees of privacy settings allowing the user to choose who can view their life goals, who can join their life goals and who can share their life goals.

20. The method of claim 1, wherein system identifies and displays products or services from vendors to a user where such products or services match the approximate location and approximate date of at least one of user's life goals.

21. The method of claim 1, wherein paid advertising is placed within displayed pages of the system whereby such advertising is paid by vendor on a pay-per-click, pay-per-view, or percent of sales basis.

22. A system for managing life goals comprising:
a social network environment;
a module configured to monitor a plurality of activities related to life goals in a social network environment;
a storage medium for storing the plurality of activities and life goals in a database;
a module configured to generate a plurality of news items and/or advertisements regarding one or more of the users life goal activities, wherein the majority of the news items and/or advertisements presented to user are related to one or more of user's life goals.

23. The system of claim 22, wherein the majority of life goals, when entered by user, are designated by date or time to be future activities.

24. The system of claim 22, wherein a privacy component configured to limit access to view user information by other users.

25. The system of claim 22, wherein the privacy component is configured to limit the access to users of the network environment.

26. The system of claim 23, wherein users may designate other users as friends which permit system to allow users to view and collaborate on the setting and accomplishment of life goals.

27. The system of claim 22, wherein the social network environment is a segmented community.

28. The system of claim 22, wherein at least one informational link comprises a dropdown menu.

29. The system of claim 22, further comprising an active link component configured to attach an active link associated with at least one of the plurality of activities to at least one of the plurality of news items.

30. The system of claim 22, wherein the display order component is configured to assign the order to the plurality of news items generated according to an order of occurrence of the plurality of news items.

31. The method of claim 1, wherein user may search for information based on goal category, vendor, product, service, or person.
